(19) United States
(12) Patent Application Publication
(10) Pub. No.: US 2025/0281877 A1
(43) Pub. Date: Sep. 11, 2025

(54) A PROCESS FOR TREATING GAS STREAMS WITH HIGH CONCENTRATION OF N2O

(71) Applicant: Topsoe A/S, Kgs. Lyngby (DK)

(72) Inventors: Janus Emil MÜNSTER-SWENDSEN, Espergærde (DK); Per Aggerholm SØRENSEN, Kgs. Lyngby (DK)

(73) Assignee: Topsoe A/S, Kgs. Lyngby (DK)

(21) Appl. No.: 18/712,118

(22) PCT Filed: Dec. 16, 2022
(86) PCT No.: PCT/EP2022/086357

§ 371 Date: May 21, 2024

(30) Foreign Application Priority Data
Dec. 23, 2021 (DK) PA202101264

(51) Int. Cl. B01D 53/86; B01D 53/34; B01J 23/00; B01J 23/75; B01J 35/57

(52) U.S. Cl. CPC B01D 53/8628; B01D 53/343; B01J 23/005; B01J 23/75; B01J 35/57; B01D 2255/20746; B01D 2255/405; B01D 2257/402; B01D 2257/404; B01D 2257/708

(57) ABSTRACT

A process for catalytically reducing N₂O concentration by more than 90% in an off-gas stream containing more than 15 vol. % N₂O, comprising the steps of
a) adding a reducing agent and a fresh dilution gas and/or a recirculated gas to the off-gas stream to provide a diluted off-gas stream;
b) introducing the diluted off-gas into a decomposing reaction of N₂O in the diluted off-gas stream by reaction with the reducing agent in presence of a catalyst containing cobalt to N₂ and O₂;
c) withdrawing a reacted outlet gas stream from step (b) having a temperature higher than 300° C. as the diluted off-gas stream introduced into step (b) due to exothermal decomposition of the N₂O; and
d) transferring heat from the outlet gas stream to the off-gas stream upstream step (b) and/or step (a) by indirect heat exchange.

N₂O is a potent greenhouse gas with about 265 times the effect of CO₂. N₂O makes a considerable contribution to decomposing ozone in the stratosphere and to the greenhouse effect. For environmental protection reasons there is therefore an increasing need for technical solutions to the problem of reducing N₂O emissions together with NOx emission from industrial processes.

Catalytic removal of N₂O is exothermic, whether done with a reducing agent or as decomposition. When the gas stream to be catalytically treated contains high concentration of N₂O, the temperature increase across the catalyst is high, resulting in high catalyst temperatures.

Fe-zeolites are well known as a catalyst to remove N₂O but are not thermally stable at high temperatures with water present in the gas.

US 2003/0143142 describes a process for removing NOx and N₂O from nitric acid production with iron loaded zeolite catalyst for decomposing N₂O at temperatures between 300° C. and 550° C.

EP1301271 describes a catalyst containing cobalt and tested at 800 C and 890 C for N₂O decomposition. The catalyst was tested for its N₂O decomposition activity with a gas containing 1200 ppm N₂O at 800 and 890 C.

U.S. Pat. No. 7,462,340 describes the use of iron zeolites for catalytic N₂O removal, but keeping the temperature below 500° C. due to the hydrothermal stability limit of the catalyst. 350 to 450° C. is mentioned as the most preferred range.

For instance adipic acid off gas contains high concentrations of N₂O, typically more than 30% and often also above 40% N₂O as apparent from the Table 1 below.

TABLE 1
Typical composition of the off gas
created in adipic acid production.

| | | Molar Percent of |
|---|---|---|
| Chemical or Common Name | Chemical Formula | Off Gas |
| Nitrous Oxide | N₂O | 30.5% |
| Nitrogen Oxide | NOₓ | 0.7% |
| Carbon Dioxide | CO₂ | 6.0% |
| Carbon Monoxide | CO | 0.03% |
| Ozone | O₂ | 3.9% |
| Water | H₂O | 2.0% |
| Dinitrogen | N₂ | 57.0% |
| Volatile Organic Compounds | Many | 0.03% |
| (“VOCs”) | | |

(https://www.climateactionreserve.org/wp-content/uploads/2019/10/Proposed-Adipic-Acid-Production-Issue-Paper_Public_FINAL.pdf)

N₂O is typically decomposed in the presence of ammonia by the following reaction:

3 N₂O+2 NH₃→4 N₂+3 H₂O

The reaction is highly exothermic. Gas streams containing a high concentration of N₂O such as more than 30 mol % need to be diluted typically with air or recirculation gas prior to contacting the gas stream with a decomposition catalyst.

Decomposition catalyst typically employed in N2O removal processes are metal exchanged zeolites, e.g. beta zeolites exchanged with Fe. Due to the low hydrothermal stability of zeolites, the gas stream would have to be diluted with dilution air to keep the reaction temperature below 500° C.

A method of keeping the maximum temperature down with reactions with a high exothermic reaction temperature is to dilute the process gas with for instance dilution air or recirculate treated process gas. Both will lower the actual N₂O concentration and thus the exothermic reaction temperature in the decomposition reactor. However, there is a cost both in terms of operating costs for blower and investment cost for all equipment due to the increased flow. Secondly the higher the outlet gas temperature is, the more valuable it is for heat recovery.

When treating off-gas streams with a high concentrations of N₂O, like off-gas from adipic acid production, the gas needs to be diluted with large amounts of dilution gas. For 30 vol. % N₂O, the dilution air flow is typically more than 4 times the process gas flow.

As the dilution gas needs to be blown into the off-gas stream, large amounts of dilution air to be blown into the off-gas stream require high energy consumption and high expenses for the suitable equipment.

This invention relates to a process for reducing N₂O concentration in a gas stream with higher than 15 vol. % N₂O.

Thus, the present invention provides a process for catalytically reducing N₂O concentration by more than 90% in an off-gas stream containing more than 15 vol. % N2O at the inlet to the catalytic treatment, comprising the steps of
a) adding a dilution gas and/or a recirculated gas to the off-gas stream to provide a diluted off-gas stream;
b) introducing the diluted off-gas into a decomposing reaction of N₂O in the diluted off-gas stream by reaction with the reducing agent in presence of a catalyst containing cobalt to N₂ and H₂O;
c) withdrawing a reacted outlet gas stream from step (b) having a temperature higher than 300° C. as the diluted off-gas stream introduced into step (b) due to exothermal de-composition of the N₂O; and
d) transferring heat from the outlet gas stream to the off-gas stream upstream step (b) and/or step (a) by indirect heat exchange.

Preferably, the cobalt containing catalyst comprises cobalt spinel.

A cobalt spinel phase catalyst is highly thermally stable and active in N₂O decomposition. The catalyst is also active at relatively low temperatures at about 300° C. to 400° C., giving a large temperature window and thus less need for dilution air or recirculation flow to keep temperature down, when treating off-gases with a high concentration of N₂O.

In order to reduce pressure drop in the N₂O decomposition the catalyst containing cobalt has preferably a monolithic or honeycomb shape.

As an example, the adiabatic temperature increase from the exothermic decomposition of for example 30 vol % N₂O would at an inlet temperature of 350° C. result in an outlet temperature of approximately 1040° C., depending naturally on the actual gas composition. Adding dilution air to keep the temperature down below 500° C., a dilution air flow of more than 400% is required, resulting in a flow more than 5 times larger than the flow to be treated.

If instead at outlet temperature of 850° C. can be accepted without damaging the catalyst, the dilution air flow can be reduced to less than 50% of the original flow. The resulting total flow is less than 30% of the flow where the maximum temperature is 500° C. This has a major impact on cost of the system.

According to the invention, the off-gas stream gas is diluted with a dilution gas (for instance ambient air or recirculated gas already treated catalytically) to an extend that results in a temperature between 600 and 900° C., preferred 700 and 900° C. and most preferred 800 and 900° C. after the catalytic decomposition of N₂O.

With an inlet temperature of 400° C., decomposing 15% of N₂O to N₂ and O₂ will give a temperature increase in an adiabatic reactor up near 750° C.—depending on actual gas composition.

The N₂O concentration must be reduced as much as possible to reduce the environmental impact of the emission and thus by at least 90%, but preferred more than 95% and most preferred more than 99%.

The diluted gas is passed over a catalyst comprising preferably cobalt spinel, which is thermally stable and active for N₂O decomposition.

The outlet gas stream is used to feed energy into the inlet gas stream for the N₂O decomposition reactor using a heat exchanger, for instance a feed/effluent heat exchanger or preheating dilution air. This can also be steam generation and then using part of this steam for heating the diluted off-gas stream or the dilution gas.

The effluent gas stream from the N₂O decomposition reactor can also be used for additional heat recovery, such as steam generation. This can be either before or after the heat exchanger feeding energy into the inlet gas stream for the N₂O decomposition reactor.

Most effective is using the outlet gas stream to first preheating dilution air and then steam generation as that gives the highest degree of energy recovery. Due to the increased gas flow and the required reaction temperature, the steam superheating and steam generation can typically cool the reacted outlet gas to a lower temperature than dilution air preheating and therefore results in higher energy recovery. The last portion of the energy can be used for steam generation.

Catalytic removal of VOC (volatile organic compounds) can be included in the catalytic N₂O decomposition for streams containing VOC. VOC can also be removed upstream and will help increase the temperature of the gas stream to be heated to a temperature suitable for N₂O decomposition.

If the off-gas stream contains NOx it is preferred to remove the NOx in an SCR stage prior and/or after the adding the dilution gas and/or the recirculated gas to the gas stream and/or simultaneously with the decomposition of the N₂O. If an SCR stage is included in the process, the off-gas stream can advantageously preheated by indirect heat exchange with the recirculated outlet gas from the N₂O composition.

In summary, preferred features of the invention are:
1. A process for reducing N₂O concentration by more than 90% in an off-gas stream containing more than 15 vol. % N₂O, comprising the steps of
   a) adding a reducing agent and a fresh dilution gas and/or a recirculated gas to the off-gas stream to provide a diluted off-gas stream;
   b) introducing the diluted off-gas into a decomposing reaction of N₂O in the diluted off-gas stream by reaction with the reducing agent in presence of a catalyst containing cobalt to N₂ and O₂;
   c) withdrawing a reacted outlet gas stream from step (b) having a temperature higher than 300° C. as the diluted off-gas stream introduced into step (b) due to exothermal decomposition of the N₂O; and
   d) transferring heat from the outlet gas stream to the off-gas stream upstream step (b) and/or step (a) by indirect heat exchange.
2. The process of feature 1, wherein the cobalt containing catalyst comprises cobalt spinel.
3. The process of feature 1 or 2, wherein the catalyst containing cobalt has a monolithic or honeycomb shape.

4. The process of any one of features 1 to 3, wherein the diluted off-gas stream is introduced into the decomposing reaction at an inlet temperature of between 250-400° C.

5. The process of any one of features 1 or 4, wherein the temperature of the reacted outlet gas stream is between 700° C. and 900° C.
6. The process according to any one of features 1 to 5, wherein the process further comprises removal of VOC.
7. The process according to any one of features 1 to 6, wherein the process further comprises removal of NOx prior and/or after the adding the dilution gas and/or the recirculated gas to the gas stream and/or simultaneously with the decomposition of the N₂O.

1. A process for catalytically reducing N₂O concentration by more than 90% in an off-gas stream containing more than 15 vol. % N₂O, comprising the steps of
a) adding a fresh dilution gas and/or a recirculated gas to the off-gas stream to provide a diluted off-gas stream with a reduced N₂O concentration;
b) introducing the diluted off-gas into a decomposing reaction of N₂O in the diluted off-gas stream in presence of a catalyst containing cobalt to N₂ and O₂;
c) withdrawing a reacted outlet gas stream from step (b) having a temperature higher than 600° C. due to exothermal decomposition of the N₂O; and
d) transferring heat from the reacted outlet gas stream to the diluted off-gas stream up-stream step (b) and/or the fresh dilution gas by indirect heat exchange.

2. The process of claim 1, wherein the cobalt containing catalyst comprises cobalt spinel.

3. The process of claim 1, wherein the catalyst containing cobalt has a monolithic or honeycomb shape.

4. The process of claim 1, wherein the diluted off-gas stream is introduced into the decomposing reaction at an inlet temperature of between 250-400° C.

5. The process of claim 1, wherein the temperature of the reacted outlet gas stream is between 700° C. and 900° C.

6. The process of claim 1, wherein the process further comprises removal of VOC.

7. The process of claim 1, wherein the process further comprises removal of NOₓ prior and/or after the adding the dilution gas and/or the recirculated gas to the gas stream and/or simultaneously with the decomposition of the N₂O.
